(19) United States
(12) Patent Application Publication
(10) Pub. No.: US 2017/0241284 A1
(43) Pub. Date: Aug. 24, 2017

(54) WHEEL DISC ARRANGEMENT

(71) Applicant: Siemens Aktiengesellschaft, Munich (DE)

(72) Inventors: Harald Hoell, Wächtersbach (DE); Kevin Kampka, Mülheim a.d. Ruhr (DE); Karsten Kolk, Mülheim a.d. Ruhr (DE); Marc Lange, Köln (DE); Peter Schröder, Essen (DE); Vyacheslav Veitsman, Gelsenkirchen (DE)

(73) Assignee: Siemens Aktiengesellschaft, Munich (DE)

(21) Appl. No.: 15/519,721

(22) PCT Filed: Oct. 8, 2015
(86) PCT No.: PCT/EP2015/073261

§ 371 Date: Apr. 17, 2017

(30) Foreign Application Priority Data
Oct. 30, 2014 (EP) 14191068.7

(51) Int. Cl. F01D 11/00; F01D 5/32; F01D 5/02

(52) U.S. Cl. CPC F01D 11/006; F01D 5/02; F01D 5/32; F05D 2220/32; F05D 2260/30

(57) ABSTRACT

A wheel disc arrangement having a wheel disc, having multiple vane devices which are fastened along an outer circumference of the wheel disc, having at least one sealing plate received between the wheel disc and the vane devices so as to be displaceable in a circumferential direction, and having at least one securing device designed so as to secure the sealing plate against a displacement in the circumferential direction, wherein the securing device has a bolt, which extends through a passage opening provided in the sealing plate, and a recess, which is provided on the wheel disc or on a vane device, which recess receives the free end of the bolt and the wall of which recess limits a movement of the bolt in the circumferential direction, wherein the bolt is, in an axial direction, secured on the sealing plate against undesired release by way of a detent connection.

### CROSS REFERENCE TO RELATED APPLICATIONS

This application is the U.S. National Stage of International Application No. PCT/EP2015/073261 filed Oct. 8, 2015, and claims the benefit thereof. The International Application claims the benefit of European Application No. EP14191068 filed Oct. 30, 2014. All of the applications are incorporated by reference herein in their entirety.

### FIELD OF INVENTION

The present invention relates to a wheel disk arrangement having a wheel disk, multiple blade devices which are attached along an outer circumference of the wheel disk, at least one sealing plate which is received between the wheel disk and the blade devices such that it can be displaced in the circumferential direction, and at least one securing device designed so as to secure the sealing plate against displacement in the circumferential direction.

### BACKGROUND OF INVENTION

Wheel disk arrangements of the type stated at the outset are known in the prior art. They form components of rotors such as gas turbine rotors or the like. Normally, multiple sealing plates are received between the wheel disk and the blade devices, such that they can be displaced in the circumferential direction. Thus, the sealing plates can for example be inserted into annular grooves which are arranged radially spaced apart from one another, and which are formed on one hand in the wheel disk and on the other hand in the blade devices. In order to ensure proper function of the sealing plates, it is necessary to secure the individual sealing plates against displacement in the circumferential direction, to which end appropriate securing devices are used. A securing device of this kind can for example be formed by a screw extending through a through-opening provided in the sealing plate, and a tapped hole which is provided in the wheel disk or in a blade device and into which the screw is screwed in the properly assembled state. However, one problem of a securing device so formed is that the notch effect associated with the tapped hole provided in the wheel disk or in the blade device negatively affects the strength of the wheel disk or of the blade device, and can give rise to corresponding problems. Furthermore, it is often the case that screws cannot be removed during servicing, which implies laborious drilling-out of the screw connection, thereby damaging the wheel disk or the blade device and thus a costly component.

### SUMMARY OF INVENTION

Starting from this prior art, it is an object of the present invention to provide a wheel disk arrangement of the type stated at the outset involving alternative construction.

To achieve this object, the present invention provides a wheel disk arrangement of the type stated at the outset which is characterized in that the securing device has a bolt extending through a through-opening which is provided in the sealing plate and a recess provided on the wheel disk or on a blade device and receives the free end of the bolt, and whose wall limits movement of the bolt in the circumferential direction, wherein the bolt is secured to the sealing plate in the axial direction by a latching connection, so as to prevent undesired release.

The fact that the bolt of the securing device according to the invention, in contrast to the prior art described in the introduction, is not screwed to the wheel disk or to a blade device but rather is held directly or indirectly by a latching connection on the sealing plate prevents the strength of the wheel disk or of the blade device being reduced by the notch effect of a thread. Furthermore, the latching connection makes the bolt quick and simple to install and remove. Even if, in isolated cases of seizing, the latching connection needed to be drilled out, this drilling would affect only the bolt and the sealing plate and no costly components such as the wheel disk or the blade device, which has a positive effect on maintenance costs.

Advantageously, the recess is designed as a longitudinal slot extending transversely to the circumferential direction. It is accordingly possible for production-related tolerances, thermal expansion or the like to be easily compensated for, since the bolt can move in the radial direction within the recess.

Advantageously, the latching connection comprises at least one latching depression and at least one latching projection which engage with one another in the radial direction.

Advantageously, the at least one latching depression is annular, thus achieving a construction that is simple and cost-effective to produce.

According to one embodiment of the present invention, there are provided two radially mutually opposite latching projections, thus achieving a very reliable latching connection.

Advantageously, at least one actuation element, which can be actuated manually or using a tool, is provided on the bolt for the purpose of releasing the latching connection. This ensures simple manual release of the latching connection.

According to one embodiment of the present invention, the at least one actuation element is designed as a resilient arm projecting axially outward, wherein the number of actuation elements advantageously corresponds to the number of latching projections.

According to one variant of the present invention, the latching connection is provided between the bolt and the sealing plate, thus achieving a construction with only a few individual components.

According to another variant of the present invention, the latching connection is provided between the bolt and a sleeve which is inserted captively into the through-opening provided in the sealing plate. A sleeve of this type has the advantage that, during servicing, it can be exchanged in a simple manner and without great costs.

The sleeve advantageously has, at its free end oriented toward the recess at least one radially projecting stop which bears axially against the sealing plate, thus securing the sleeve in the axial direction on the sealing plate.

### BRIEF DESCRIPTION OF THE DRAWINGS

Further features and advantages of the present invention will become clear from the following description of wheel disks according to embodiments of the present invention, with reference to the appended drawing, in which:

FIG. 1 is a cross-sectional view of a region of a wheel disk arrangement according to a first embodiment of the present invention;

FIG. 2 is a perspective view of a bolt, shown in FIG. 1, of a securing device;

FIG. 3 is a front view of the detail, shown in FIG. 1, of the wheel disk;

FIG. 4 is a cross-sectional view of a region of a wheel disk arrangement according to a second embodiment of the present invention;

FIG. 5 is a perspective section view of a sleeve of a securing device of the wheel disk arrangement shown in FIG. 4; and

FIG. 6 is a perspective section view of a bolt of the securing device of the wheel disk arrangement shown in FIG. 4.

### DETAILED DESCRIPTION OF INVENTION

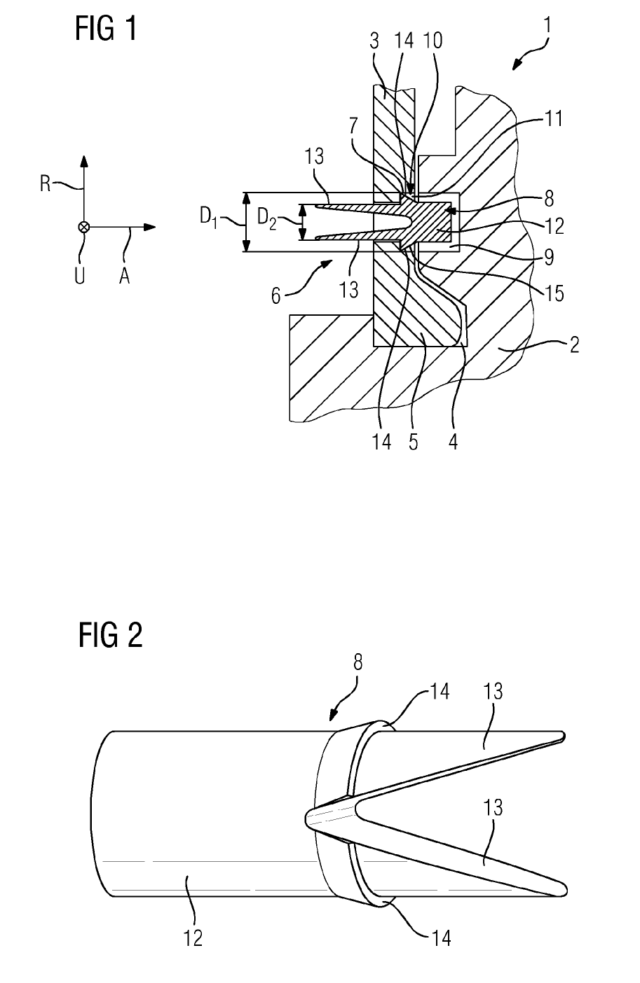

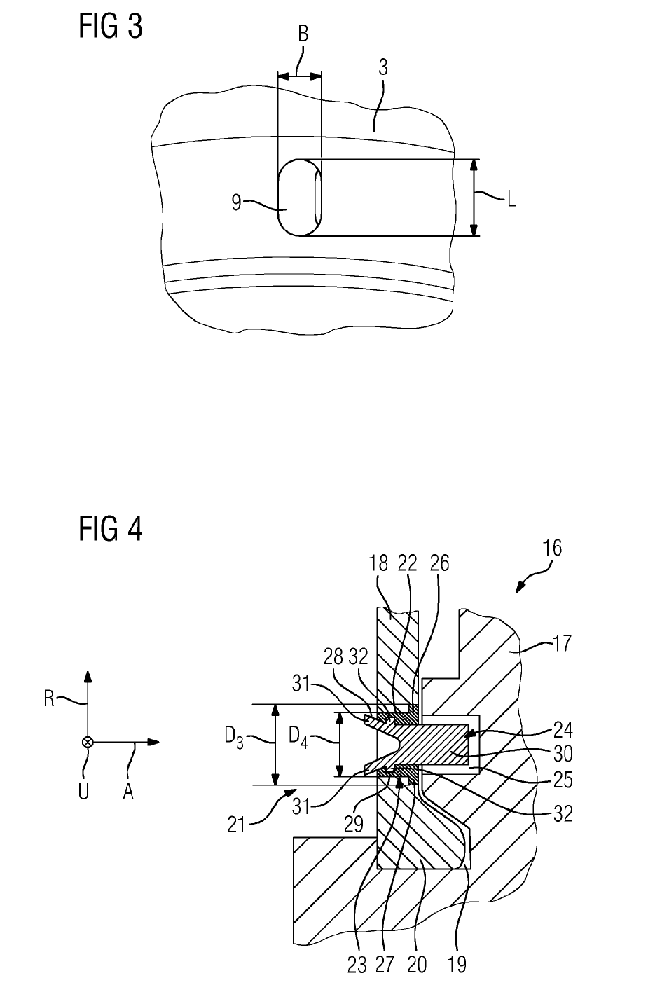

FIGS. 1 to 3 show a detail of a wheel disk arrangement 1 according to a first embodiment of the present invention. The wheel disk arrangement 1 comprises a wheel disk 2, multiple blade devices (not shown in greater detail) which are attached along an outer circumference of the wheel disk 2, and multiple sealing plates 3 which extend between the wheel disk 2 and the blade devices, and are received such that they can be displaced in the circumferential direction U. More precisely, the sealing plates 3 are inserted into annular grooves which are arranged spaced apart from one another in the radial direction R, the annular grooves being formed on one hand in the wheel disk 2 and on the other hand in the blade devices. FIG. 1 shows only the undercut annular groove 4 which is formed in the wheel disk 2 and into which are inserted beads 5 formed on the radially inward oriented edges of the sealing plates 3.

In order to secure the sealing plates 3 against displacement in the circumferential direction U, the wheel disk arrangement 1 comprises multiple securing devices 6. Each securing device 6 has a bolt 8 extending through a through-opening 7 provided in a sealing plate 3, and a recess 9 which is provided in the wheel disk 2 and receives the free end of the bolt 8.

The bolt 8 is secured to the sealing plate 3 in the axial direction A by a latching connection 10, so as to prevent undesired release. To that end, the through-opening 7 has, in the axial direction, two coaxial sections with different diameters D₁ and D₂, wherein the diameter D₁ of that section oriented toward the recess 9 is greater than the diameter D₂ of that section oriented away from the recess 9. A latching depression 11 is accordingly defined between the two sections. In order to create the through-opening 7, it is for example possible for the smaller bore with diameter D₂ to be drilled through, while the larger bore with diameter D₁ is merely counterbored. The bolt 8 comprises a cylindrical bolt head 12, adjoining which are two actuation elements 13 in the form of resilient arms, which are radially opposite one another and extend in the axial direction. Latching projections 14, which are arranged radially opposite one another, are provided in the transition region between the bolt head 12 and the actuation elements 13, wherein each latching projection 14 has, on its side oriented toward the bolt head 12, a beveled surface 15 whose diameter reduces in the direction of the bolt head 12 so as to produce an insertion aid. The position of the latching projections 14 is chosen such that they are moved toward one another when the actuation elements 13 are squeezed together.

The recess 9 is in the form of a longitudinal slot extending in the radial direction R. The breadth B of the longitudinal slot is chosen to be slightly larger than the diameter of the bolt head 12 such that the bolt head 12 can be inserted into the recess 9. This limits movement of the bolt head 12, and thus of the bolt 8, in the circumferential direction U. The length L of the longitudinal slot is greater than the breadth B thereof, and as a result the bolt head 12 can be moved in the radial direction R within the recess 9 in order to compensate for thermal expansion or the like.

In order to radially secure a sealing plate 3 arranged between the annular grooves of the wheel disk arrangement 1, in a first step the through-opening 7 and the recess 9 are brought into alignment with one another by moving the sealing plate 3 in the circumferential direction U accordingly. Then, the bolt 8 is inserted, with the bolt head 12 first, into the through-opening 7 until the beveled surfaces 15 of the latching projections 14 come into contact with that edge of the through-opening 7 that defines the smaller diameter D2. Now, the bolt 8 is pushed further in the direction of the recess 9 under application of force. In so doing, the latching projections 14 are moved toward one another to the extent that they can be inserted entirely into the through-opening 7. Once the latching projections 14, in the context of continued forward movement of the bolt head 12, have passed the latching depression 11, the actuation elements 13 snap apart from one another. The latching connection thus generated secures the bolt 8 in the axial direction A, as shown in FIG. 1. Also, the sealing plate 3 is prevented from moving in the circumferential direction by virtue of the bolt head 12 received in the recess 9.

In order to release the bolt 8, the actuation elements 13 projecting out from the sealing plate 3 must be pressed together, simply manually or using a suitable tool, whereupon the bolt 8 can be removed from the through-opening 7.

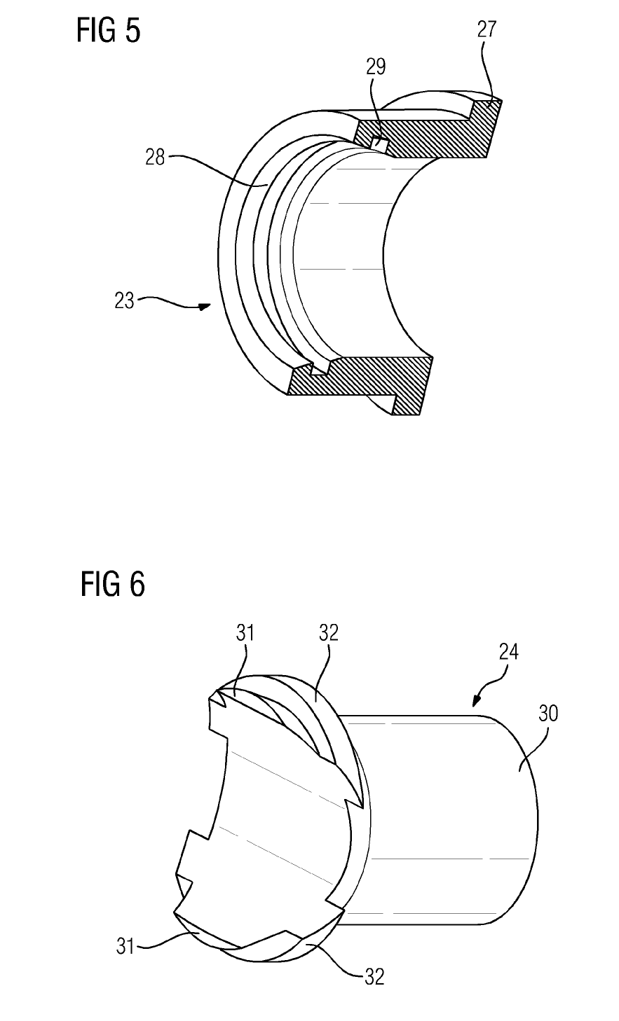

FIGS. 4 to 6 show a wheel disk arrangement 16 according to a second embodiment of the present invention. The wheel disk arrangement 16 comprises a wheel disk 17, multiple blade devices (not shown in greater detail) which are attached along an outer circumference of the wheel disk 17, and multiple sealing plates 18 which extend between the wheel disk 17 and the blade devices, and are received such that they can be displaced in the circumferential direction U. More precisely, the sealing plates 18 are inserted into annular grooves which are arranged spaced apart from one another in the radial direction R, the annular grooves being formed on one hand in the wheel disk 17 and on the other hand in the blade devices. FIG. 4 shows only the undercut annular groove 19 which is formed in the wheel disk 17 and into which are inserted beads 20 formed on the radially inward oriented edges of the sealing plates 18.

In order to secure the sealing plates 18 against displacement in the circumferential direction U, the wheel disk arrangement 1 comprises multiple securing devices 21. Each securing device 21 has a sleeve 23 extending through a through-opening 22 provided in a sealing plate 18, a bolt 24 extending through the sleeve 23, and a recess 25 which is provided in the wheel disk 17 and receives the free end of the bolt 24.

The through-opening 22 is divided in the axial direction into two coaxial sections with different diameters D₃ and D₄, wherein the diameter D₃ of that section oriented toward the recess 25 is greater than the diameter D₄ of that section oriented away from the recess 25. A shoulder 26 is accordingly defined between the two sections. In order to create the through-opening 22, it is for example possible for the smaller bore with diameter D₄ to be drilled through, while the larger bore with diameter D₃ is merely counterbored.

The outer contour of the sleeve 23 is made to match the contour of the through-opening 22. Accordingly, the sleeve has, at its free end oriented toward the recess 25, an annular retaining projection 27 which projects radially outward and defines a stop. At the opposite free end, the inner wall of the sleeve 23 defines an insertion cone 28 which is provided with an annular encircling latching depression 29.

The bolt 24 comprises a cylindrical bolt head 30, adjoining which are two actuation elements 31 in the form of resilient arms, which are radially opposite one another and extend essentially in the axial direction A, and which widen in the radial direction R in the manner of a cone corresponding to the insertion cone 28 of the sleeve 23. Latching projections 32, which are arranged radially opposite one another and project outward, are provided in the transition region between the bolt head 30 and the actuation elements 31. The position of the latching projections 32 is chosen such that they are moved toward one another when the actuation elements 31 are squeezed together.

The form of the recess 25 is similar to that of the recess 9 of the wheel disk arrangement 1 according to the previously described first embodiment, and will therefore not be described anew here.

In order to radially secure a sealing plate 18 arranged between the annular grooves of the wheel disk arrangement 16, in a first step the sleeve 23 is inserted from behind into the through-opening 22 of the sealing plate 18 until it abuts against the sealing plate 18. Then, the through-opening 22 is brought into alignment with the recess 25 by moving the sealing plate 18 in the circumferential direction U accordingly. Then, the bolt 24 is inserted, with the bolt head 30 first, into the sleeve 23 until the latching projections 32 of the bolt 24 snap into the associated latching depression 29 of the sleeve 23. The latching connection thus generated secures the bolt 24 in the axial direction A, as shown in FIG. 4. Also, the sealing plate 18 is prevented from moving in the circumferential direction U by virtue of the bolt head 30 received in the recess 25.

In order to release the bolt 24, the actuation elements 31 projecting out from the sealing plate 18 must be pressed together, simply manually or using a suitable tool, whereupon the bolt 24 can be removed from the sleeve 23.

An essential advantage of the above-described securing devices 6, 21 of the wheel disk arrangements 1, 16 is that they secure, in a simple manner, the sealing plates 3, 18 against movement in the circumferential direction U, without the strength of the wheel disks 2, 17 being impaired by a notch effect. At this point, it should be noted that, according to the invention, the recesses 9, 25 can alternatively or additionally also be provided in blade devices, even though this is not shown here. Furthermore, the securing devices 6, 21 are advantageous with regard to their simple construction and with regard to their capacity to be easily installed and removed.

Although the invention has been described and illustrated in detail by way of the preferred exemplary embodiment, the invention is not restricted by the disclosed examples and other variations can be derived herefrom by a person skilled in the art without departing from the scope of protection of the invention.

1. A wheel disk arrangement comprising:
a wheel disk,
multiple blade devices which are attached along an outer circumference of the wheel disk,
at least one sealing plate which is received between the wheel disk and the blade devices such that it is displaceable in the circumferential direction, and
at least one securing device designed so as to secure the sealing plate against displacement in the circumferential direction,
wherein the securing device has a bolt extending through a through-opening which is provided in the sealing plate and a recess which is provided on the wheel disk or on a blade device and receives the free end of the bolt, and whose wall limits movement of the bolt in the circumferential direction,
wherein the bolt is secured to the sealing plate in the axial direction by a latching connection, so as to prevent undesired release.

2. The wheel disk arrangement as claimed in claim 1,
wherein the recess is designed as a longitudinal slot extending transversely to the circumferential direction.

3. The wheel disk arrangement as claimed in claim 1,
wherein the latching connection comprises at least one latching depression and at least one latching projection which engage with one another in the radial direction.

4. The wheel disk arrangement as claimed in claim 3,
wherein the at least one latching depression is annular.

5. The wheel disk arrangement as claimed in claim 3, further comprising:
two radially mutually opposite latching projections.

6. The wheel disk arrangement as claimed in claim 3, further comprising:
at least one actuation element, which is actuated manually or using a tool, on the bolt for the purpose of releasing the latching connection.

7. The wheel disk arrangement as claimed in claim 6,
wherein the at least one actuation element is designed as a resilient arm projecting axially outward.

8. The wheel disk arrangement as claimed in claim 6,
wherein the number of actuation elements corresponds to the number of latching projections.

9. The wheel disk arrangement as claimed in claim 1,
wherein the latching connection is provided between the bolt and the sealing plate.

10. The wheel disk arrangement as claimed in claim 1,
wherein the latching connection is provided between the bolt and a sleeve which is inserted captively into the through-opening provided in the sealing plate.

11. The wheel disk arrangement as claimed in claim 10,
wherein the sleeve has, at its free end oriented toward the recess, at least one radially projecting stop which bears axially against the sealing plate.
